(19) United States
(12) Patent Application Publication
(10) Pub. No.: US 2006/0008557 A1
(43) Pub. Date: Jan. 12, 2006

(54) Nutritional frozen dessert formulations and methods of manufacture

(75) Inventors: Theodore B. Vanitallie, Boca Grande, FL (US); Nicholas Melachouris, Laguna Niguel, CA (US); Donald Grindstaff, Apple Valley, MN (US)

Correspondence Address: WILLKIE FARR & GALLAGHER LLP;INTELLECTUAL PROPERTY LEGAL ASSISTANTS, 787 SEVENTH AVE, NEW YORK, NY, 10019-6099, US

(73) Assignee: COGNATE NUTRITIONALS LLC, Burnsville, MN (US)

(21) Appl. No.: 10/889,550

(22) Filed: Jul. 12, 2004

(51) Int. Cl. A23G 3/20

(52) U.S. Cl. 426/100

(57) ABSTRACT

Frozen or semi frozen food products comprise corn syrup solids, a dry blend of protein and stabilizer, and vegetable oil and are characterized in that they have high caloric density, high protein content, a fatty acid profile beneficial for healthy cardiovascular function, and exhibit desirable physical and sensory qualities. The protein fortified food products are useful in the treatment or prevention of protein-calorie malnutrition etc. The products are generally high in caloric density and high in protein content and retain the physical and sensory organoleptic qualities of traditional ice cream made with milkfat and have a beneficial fatty acid profile and no cholesterol or lactose.

### BACKGROUND OF THE INVENTION

Conventional ice cream is typically a highly sought after dessert made from milk, cream, sugar, and flavoring, and generally having a rich, cool and creamy mouth-feel, a pleasing body and texture, melting quality, color and appearance. But ice cream is generally not considered particularly healthy, as it contains high quantities of milk fat and cholesterol. Many substitutes for conventional ice cream have been developed which mitigate some of the health concerns, but typically do not provide the same level of satisfaction as conventional ice cream.

Corn syrup solids are dried syrups made from corn (maize), and is composed mainly of fructose. It is used to sweeten soft drinks, juices, ice cream, and many other mass-produced foods.

Proteins are one of the three main components of diet (together with fats and carbohydrates). They consist of amino acids joined by peptide bonds. Protein is essential to the structure and function of all living cells and viruses. In humans, for example, proteins may be enzymes or subunits of enzymes. Other proteins play structural or mechanical roles, such as those that form the struts and joints of the cytoskeleton.

Protein deficiency in humans can lead to symptoms such as fatigue, insulin resistance, hair loss, loss of hair pigment (hair that should be black becomes reddish), loss of muscle mass (proteins repair muscle tissue), low body temperature, and hormonal irregularities. Severe protein deficiency is fatal.

Stabilizers may be added to foods to prevent or retard an unwanted change in physical state of a food product. For example, stabilizers such as gelatin, pectin, and carrageenan may be used to prevent the formation of ice crystals in ice cream.

Vegetable oils may be extracts from oilseeds or other plant sources. Like all fats, vegetable oils are esters of glycerin and a varying blend of fatty acids. Common sources of vegetable oil include: flax seed, linseed, rapeseed canola (a special variety of rapeseed, bred to minimize toxin content), safflower, sesame seed, sunflower, grape seed oil, almond, avocado, castor bean, corn (maize), cotton seed, coconut, hazelnut, olive oil, palm (from the fruit of the African palm tree), palm kernel oil (from the seed of the African palm tree), peanut, pumpkin seed, rice bran, soybean and walnut.

Saturated fats are found in foods from both animal and vegetable sources. Animal sources include meat, poultry, and whole-milk dairy products such as cheese, milk, ice cream, cream, butter, and lard. Vegetable sources—including coconut, palm kernel, and palm oils—are also high in saturated fat. Unsaturated fat is a type of fat that is usually liquid at refrigerator temperature. Monounsaturated and polyunsaturated fat are two kinds of unsaturated fat. Monounsaturated fat is found in large amounts in foods from plants, including olive oil, peanut, avocado, and canola oil (from rapeseed). It is a slightly unsaturated fat. Polyunsaturated fat is highly unsaturated fat that is found in large amounts in foods from plants, including safflower, sunflower, corn, and soybean oil. Omega-three fatty acid (fish oil) is a polyunsaturated fat found in seafood, particularly fish that is fatty.

Approximately 40% of the calories consumed in the United States are from fat. Current recommendations for healthy cardio vascular function for adults and children over the age of two are to reduce the total fat intake to 30% or less of the total daily calories. Saturated fat should be limited to 10% of the total calories for the day. The remainder of the day's fat intake should be equal amounts of polyunsaturated and monounsaturated fat. However, children under two years of age should NOT be on a fat restricted diet because cholesterol and fat are thought to be important nutrients for brain development.

Calorie density is the number of calories per weight of food. It is a measure of the total energy available from a unit amount of a food. For people having a difficult time consuming a lot of food, higher caloric density foods will help them obtain sufficient calories for nutritional support.

### SUMMARY OF THE INVENTION

In general, in a first aspect, the invention features a frozen or semi frozen food product comprising corn syrup solids, a dry blend including protein and stabilizer and vegetable oil. The product is characterized in that it has high caloric density, high protein content, a fatty acid profile beneficial for healthy cardiovascular function, and exhibits satisfactory physical and sensory qualities.

In general, in a second aspect, the invention features a frozen or semi frozen food product comprising corn syrup solids and a dry blend comprising protein and stabilizer, and vegetable oil having a fatty acid profile beneficial for healthy cardiovascular function and having high caloric density and high protein content. The product is characterized in that it exhibits satisfactory physical and sensory qualities.

In general, in a third aspect, the invention features a protein fortified food product comprising protein-calorie malnutrition ameliorating amounts of corn syrup solids, a dry blend including protein and stabilizer, and vegetable oil having a fatty acid profile beneficial for healthy cardiovascular function and having high caloric density and high protein content.

In general, in a fourth aspect, the invention features a method of manufacturing a frozen or semi frozen food product comprising the steps of adding a dry blend including protein and stabilizer to aqueous corn syrup solids and dispersing the ingredients, mixing in vegetable oil having a fatty acid profile beneficial for healthy cardiovascular function and cooling and aerating. The product thus formed is characterized in that it has high caloric density and high protein content.

In general, in a fifth aspect, the invention features a high caloric density and high protein content frozen or semi-frozen food or dessert product comprising corn syrup solids in an amount of about 5% to 25% by weight, sugar or corn syrup in an amount of about 5% to 25% by weight, protein in an amount of from about 8% to about 35% by weight and preferably in an amount from about 15% to about 25%, by weight stabilizer in an amount of up to about 1% by weight and preferably up to about 0.2 percent by weight, and vegetable oil having a fatty acid profile beneficial for healthy cardiovascular function in an amount of from about 5% to about 18% by weight.

Embodiments of the invention may include one or more of the following additional features. The corn syrup solids may comprise high fructose corn syrup solids. The dry blend may comprise one or more of whey protein isolate, whey protein concentrate, milk protein concentrate, soy protein isolate, milk protein isolate and caseinate. The dry blend may include sucrose. The dry blend includes artificial sweetener. The vegetable oil may comprise one or more of safflower oil, mixtures including safflower oil, canola oil, mixtures including canola oil, sunflower oil, mixtures including sunflower oil, corn oil, mixtures including corn oil, soybean oil, mixtures including soybean oil, cottonseed oil and mixtures including cottonseed oil. The fatty acid profile has under about 20 percent saturated fat and preferably about 8 percent saturated fat. The food product may comprise palm kernel oil. The food product may have substantially no cholesterol. The food product may have substantially no trans fatty acids. The food product may have substantially no lactose. The food product may have substantially no bulking agents, fillers or gums. The food product may have physical and sensory qualities substantially similar to traditional ice cream made with milk fat. The product generally is calorie-dense and/or protein fortified. The product generally has a beneficial fatty acid profile.

The above features and combinations of features, and their advantages are of representative embodiments only. It should be understood that they are not to be considered limitations on the invention as defined by the claims. Additional features and advantages of the invention will become apparent in the following description, from the drawing, and from the claims.

The invention accordingly comprises the several elements, and the combination of one or more of such elements with respect to each of the others; and the several steps and the relation of one or more of such steps with respect to each of the others, which are adapted to manufacture such combination, all as exemplified in the following detailed disclosure.

### BRIEF DESCRIPTION OF THE DRAWING

For a more complete understanding of the present invention and its associated advantages, reference is now made to the following description taken in conjunction with the accompanying drawing, in which:

FIG. 1 is a flowchart of a manufacturing process.

### DETAILED DESCRIPTION

Generally speaking, frozen or semi-frozen food or dessert products for nutritional support, and particularly, ice-cream-like food or dessert products fortified with protein, are provided. In addition, methods of manufacturing nutritional frozen or semi-frozen food or dessert products are provided. The food product may be formulated for good taste, good organoleptic qualities, and to be beneficial as an palatable protein and energy source.

The nutritional frozen dessert products, such as ice cream and the like, are designed to provide nutritional support to frail elderly, hospitalized patients, malnourished individuals, or individuals with difficulties in chewing and swallowing, lack of appetite, nausea, or inadequate feeding assistance. In particular, the product is especially beneficial in ameliorating protein-calorie malnutrition.

There are various medical reasons why high caloric density food products, especially food products fortified with protein, are desired. Among people for whom such products may be beneficial or even life-saving are those who suffer from, or are at risk of developing, protein-calorie malnutrition (PCM), also known as protein-energy malnutrition (PEM). Examples include: (1) frail, elderly or infirm individuals—particularly those with loss of appetite, or who experience difficulty in chewing and/or swallowing; (2) post-operative patients (e.g., with pre- and/or postsurgical weight loss); (3) people who suffer from any of an array of serious health problems such as cancer (and, all too often the associated side effects of chemotherapy and radiation), pulmonary disease (e.g., chronic pulmonary insufficiency), heart disease (e.g., chronic congestive heart failure with cardiac cachexia), gastrointestinal disease (e.g., ulcerative colitis or Crohn's disease), endocrine disease (e.g., hyperthyroidism), a compromised immune system (e.g., AIDS); and (4) those who, for any of a variety of reasons (e.g., poverty, alcoholism, drug abuse, ignorance) habitually consume a nutritionally inadequate diet.

The protein generally available in nutritional supplements that are relatively high in protein but relatively low in calorie content may not be used with satisfactory efficiency in either healthy individuals or—more important—to replenish body protein in patients who suffer from protein malnutrition. This is because optimal utilization of dietary protein is dependent on the simultaneous provision of an adequate supply of energy (total calories). As pointed out by Peters and Van Slyke, Quantitative Clinical Chemistry: Interpretations, Vol. 1, page 37, Second edition Williams and Wilkins, Baltimore, 1946, “Within certain limits the amount of protein required to secure nitrogen equilibrium is inversely proportional to the caloric value of the diet.” In the 10^{th} edition of Recommended Dietary Allowances (RDA) published by the National Research Council, 1989, the following statement is made (p 54): “Protein synthesis and breakdown are energy-dependent and thus are sensitive to dietary energy deprivation.” The 6^{th} edition of RDA, 1980, page 42, cites the work of Inoue et al (1973) who compared the amount of egg protein needed to bring young Japanese men into nitrogen equilibrium at two levels of caloric intake. At 57 kcal/kg of body weight, the minimum protein intake needed to ensure nitrogen equilibrium in 97.5% of subjects was 0.49 g/kg, whereas at 45 kcal/kg the minimum needed increased to 0.74 g/kg. The relationship of protein utilization (positive nitrogen balance) to energy intake has been examined in laboratory animals by J. B. Allison (see Mammalian Protein Metabolism, H. N. Munro and J. B. Allison, eds. (Vol. 1, pp. 381-481) New York Academic Press, 1964). In a summarizing figure (p. 420), Allison shows that, in a diet adequate in protein an increasing energy intake is associated with an increasingly positive nitrogen balance (reflecting enhanced protein utilization). From studies like these, it is evident that a nutritional supplement designed to enhance an individual's protein nutriture should provide a sufficient quantity of highly digestible protein of high biological value together with enough calories to ensure utilization of the protein moiety.

The product may include corn syrup solids, a dry blend of protein and stabilizer, and vegetable oil; and may be characterized by any or several of the following qualities: it may have a high caloric density; it may have a high protein content with about 20 to 25 percent of the calories from protein (around 10 to 15 percent by weight). It may have a high-percentage of vegetable oil within the total fat content or is preferably made exclusively with vegetable oil while nonetheless retaining the physical and sensory qualities of traditional ice cream made with milkfat. It may have a fatty acid profile preferably exceeding the pattern recommended by the American Heart Association for a healthy cardiovascular system, particularly, a low saturated fat content of under 20 percent, and more particularly a low saturated fat content of about 8 percent, a polyunsaturated fat content of about 50 percent and monounsaturated fat content of about 42 percent. It may have no cholesterol. It may contain no lactose. It may optionally include other nutrients such as omega-3 fatty acids and antioxidants.

The product may optionally include palm kernel oil in the oil mix to affect textural properties of the product. Although one would not typically consider using palm kernel oil when developing a product with extremely low saturated fat content (because this oil is high in saturated fat), in the present product, small amounts do not materially change the saturated fat content. And, the addition of palm kernel oil may improve the melting quality of the product because of the higher melting point of this oil.

Regarding the fatty acid profile, the recommended fatty acid distribution according to the American Heart Association (“AHA”) is:

| | |
|---|---|
| Saturated: | 8-10% of calories in diet |
| Polyunsaturated: | Up to 10% of calories in diet |
| Monounsaturated: | Up to 15% of calories in diet. |

Thus the total maximum amount of fatty acids recommended is thus: 33-35% (8 or 10+10+15) of calories in diet.

If one assumes a 2000 kcal per day diet and a typical proportion of calorigenic nutrients in the diet approximating 15% protein, 35% fat and 50% carbohydrate, the fat should make up about 700 kcal per day (200 calories from saturated fat, 200 calories from polyunsaturated fat, and 300 calories from monounsaturated fat.

Thus, the recommended fatty acid profile distribution maxima are about:

| | |
|---|---|
| Saturated: | 28.6% of the fat calories |
| Polyunsaturated: | 28.6% of the fat calories |
| Monounsaturated: | 42.8% of the fat calories. |

But, generally, the lower the saturated fatty acid content, the better.

In some embodiments of the product, it may have a saturated fat content reduced to about 8-15% of the fat calories and polyunsaturated fat content is increased to about 40-51% of fat calories and the monounsaturated fat content is about 41-45%. In other embodiments the monounsaturated fat content is increased instead of the polyunsaturated fat content, for example by using High Oleic sunflower oil.

In addition, the AHA recommends a certain intake of omega-3 fatty acids. Embodiments of the food product can include Canola oil relatively rich in alpha-linolenic acid (omega-3).

Vegetable oils may be used for their beneficial effect on serum cholesterol levels. In general, the higher the ratio of polyunsaturated fat to saturated fat in the oil the greater the cholesterol-lowering effect. While vegetable oils which are high in polyunsaturated fats do lower total cholesterol, they may also reduce the level of HDL cholesterol (the so-called “good cholesterol”). However since monounsaturated content does not cause such a reduction of HDL cholesterol, more desirable cholesterol lowering effects are obtained from higher ratios of monounsaturated fat to saturated fat in the vegetable oil. Canola oil, for example, provides the preferred high concentrations of monounsaturated fat relative to polyunsaturated fats (greater than 2 to 1) and therefore provides cholesterol-lowering effects with less impact on the HDL cholesterol (Canola has a Monounsaturated/Saturated ratio of 9.1; and a Monounsaturated/Polyunsaturated ratio of 2.2).

In a general sense, frozen or semi-frozen food or dessert products for nutritional support, i.e., ice-cream-like food or dessert products fortified with protein, comprise corn syrup solids and sucrose in an amount of about 5% to about 25% by weight of the composition, protein in an amount of from about 8% by weight to about 35% by weight of the composition, preferably from about 15% by weight to about 25% by weight of the composition, stabilizer in an amount of up to about 1% or more by weight of the composition, and preferably, up to about 0.5% by weight of the composition, and more preferably up to about 0.2% by weight of the composition, and vegetable oil in an amount of about 5% to about 18%.

Protein content may be maintained high enough to provide the protein nutritional support desired, but not so high that the product becomes grainy and/or hard. Vegetable oil content may be kept low enough to avoid undesirable flavor notes or undesirable melting properties of the food. Higher levels of stabilizer result in a product that may be more difficult to extrude and aerate.

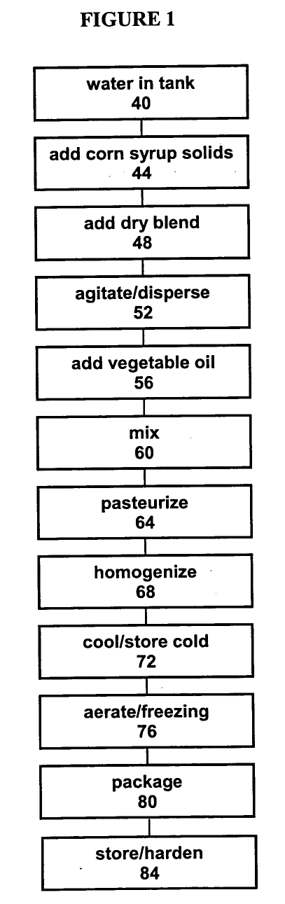

The product can be manufactured by a process similar to the process of manufacturing conventional ice cream and ice cream-like products or other frozen or semi frozen foods. A preferred embodiment of a method of manufacturing the product can be understood by referring to the flowchart shown in FIG. 1. First, start with adding water to a suitably sized tank 40, and add corn syrup solids 44.

Add a dry blend 48 comprising whey protein (or other protein or mix of proteins), sucrose and sucralose (Splenda) sweetener or the like, and stabilizer and agitate to disburse the ingredients 52. Some sucrose is particularly recommended to “round” the sweetness and the flavor of the product.

Whey protein has been associated with enhancing human immune function and wound healing, as well as remedying other conditions and being considered an exemplary food with respect to nutritional value for growing children. Alternatively, the total protein component of the dry blend may be or may include soy protein and the like. The dry blend is typically pre-blended to disperse the stabilizer, which advantageously helps eliminate foaming.

Stabilizer is added in order to ensure that the composition remains in suspension and provides aeration and emulsifying agents. Any typical stabilizer, such as gelatin, pectin, and carrageenan, may be used.

Add vegetable oil 56 such as safflower or canola oil, or other oils having a desirable fatty acid profile, and mix 60. While oils of this nature, particularly unsaturated fatty acids, typically might oxidize due to the presence of unsaturated bonds, the whey protein advantageously seems to protect the fat globules. Alternatively, antioxidants may be added at this stage or together with, or prior to, the addition of the flavors.

Pasteurization 64 is then done in a high-temperature short time pasteurizer (HTST), e.g., at 175 degrees Fahrenheit for 25 to 30 seconds. HTST pasteurization is preferred in particular because whey proteins can otherwise sometimes coagulate when heated.

The pasteurized mix is then homogenized 68 in a two-phase homogenizer for a total pressure of about 2,500 psi.

Then, allow the mixture to cool to ambient temperature and store cold overnight 72 to hydrate the ingredients and to provide for the appropriate fat crystalline structure

Air is incorporated in a conventional manner (overrun approximately from about 30% to about 130%, and preferably about 90%) while freezing 76 (at about 23 degrees Fahrenheit), and the product is packaged 80 in conventional containers or bulk packaging based on the target applications. Storing the packaged product 84 in a hardening room at about −20 degrees Fahrenheit stabilizes the product and retards spoiling.

Two exemplary formulations of different flavored products are now illustrated:

| Ingredients % | Vanilla Flavor | Chocolate Flavor |
|---|---|---|
| Safflower Oil | 5.4 | 5.4 |
| High Oleic Sunflower or Canola Oil | 6.6 | 6.6 |
| Whey Protein Isolate | 15 | 15 |
| Sucrose | 7.25 | 7.25 |
| Corn Syrup Solids | 7.25 | 7.25 |
| Stabilizer | 0.2 | 0.2 |
| Sucralose | 0.02 | 0.02 |
| Cocoa Powder | 0 | 4 |
| Water | 58.3 | 54.3 |

These formulations have the following nutritional characteristics:

| Calories Per 100 g | Vanilla | Chocolate |
|---|---|---|
| Total | 225 | 254 |
| Calories From Protein (%) | 25 | 22 |
| Calories From Carbohydrate (%) | 26 | 26 |
| Calories From Fat (%) | 49 | 52 |

Table 1 lists the composition of five formulations manufactured under commercial conditions and tested for flavor and organoleptic quality. The variables included the effective protein concentration, the addition of the stabilizer and of cocoa powder.

TABLE 1
ICE CREAM FORMULAS

| | FORMULA: | | | | |
|---|---|---|---|---|---|
| Ingredient (%) | 1* | 2* | 3* | 4* | 5 |
| Safflower Oil | 5.4 | 5.4 | 5.4 | 5.4 | 5.4 |
| Canola Oil | 6.6 | 6.6 | 6.6 | 6.6 | 6.6 |
| Whey protein isolate | 11.06 | 11.06 | 15 | 15 | 11.06 |
| Sucrose | 7.25 | 7.25 | 7.25 | 7.25 | 7.25 |
| Corn syrup solids | 7.25 | 7.25 | 7.25 | 7.25 | 7.25 |
| Stabilizer | 0 | 0.2 | 0 | 0.2 | 0.2 |
| Sucralose | 0.02 | 0.02 | 0.02 | 0.02 | 0.02 |
| Cocoa powder | 0 | 0 | 0 | 0 | 4 |
| Water | 62.4 | 62.2 | 58.5 | 58.3 | 58.2 |

*vanilla flavored

Products made with the five formulations exhibited traditional ice cream-like qualities. The flavor was clean and pleasant. Color was white for the vanilla flavored products and typical chocolate color for the chocolate containing product. The incorporation of high concentration of whey proteins did not affect the body and texture of the products. The products had an acceptable softness, a smooth body and proper melting characteristics. The use of stabilizer was beneficial for the quality of the product and especially during processing of the ice cream mix.

Table 2 provides detailed compositional and nutritional information of formulations 1-5 from Table 1 above.

TABLE 2
ICE CREAM NUTRITION COMPOSITION
FOR FORMULATIONS IN TABLE 1

| | FORMULATION | | | | |
|---|---|---|---|---|---|
| | 1 | 2 | 3 | 4 | 5 |
| Protein(%) | 10.5 | 10.5 | 14.1 | 14.1 | 14.1 |
| Fat(%) | 12 | 12.2 | 12 | 12.2 | 14.8 |
| Carbohydrate(%) | 14.6 | 14.7 | 14.6 | 14.7 | 16.1 |
| Calories From: | | | | | |
| Protein | 42 | 42 | 56 | 56 | 56 |
| Fat | 108 | 110 | 108 | 110 | 133 |
| Carbohydrate | 58 | 59 | 58 | 59 | 64 |
| Total Calories | 208 | 211 | 222 | 225 | 253 |
| Calories(%) From: | | | | | |
| Protein | 20 | 20 | 25 | 25 | 22 |
| Fat | 52 | 52 | 49 | 49 | 53 |
| Carbohydrate | 28 | 28 | 26 | 26 | 25 |
| Fatty Acid | | | | | |
| Distribution(%) | (All for- | | | | |
| | mulations) | | | | |
| Saturated | 8 | | | | |
| Polyunsaturated | 50 | | | | |
| Monounsaturated | 42 | | | | |

Note, the 15% by weight protein isolate of formulations 3 and 4 yield approximately 25% of calories from protein. Formulations 1 and 2, with 11% protein isolate by weight, yields approximately 20% of calories from protein. Note also, the high fat percentage (almost 50% of calories) imparts a creaminess equivalent to the high fat conventional premium ice cream products.

The values indicated by weight are corrected for moisture, ash and residual lactose, if any. In general, the percent of total calories is more important as a basis for comparison than the weight in grams. As a comparison, conventional premium ice cream products such as Haagen Dazs include 60% fat by calories and 7% protein by calories. Note, the product herein described, having only about 26% of calories as carbohydrate, is thus a much lower carbohydrate dessert than Haagen Dazs, having about 33% of its calories as carbohydrates.

Table 3 provides the formulation and nutritional information of commercially manufactured and tested formulations incorporating palm kernel oil and/or milk protein concentrate.

TABLE 4
FORMULATIONS WITH OTHER
FAT AND PROTEIN SOURCES

| | 6 | 7 |
|---|---|---|
| Ingredient (%) | | |
| Palm Kernel Oil (*) | 3.12 | |
| Safflower Oil | 3.84 | |
| High Oleic Sunflower or Canola | 5.04 | 6 |
| Shortening (**) | | 6 |
| Milk Protein Concentrate | | 6.17 |
| Whey Protein Isolate | 11.06 | 5.58 |
| Sucrose | 7.25 | 7.25 |
| Corn syrup solids | 7.25 | 7.25 |
| Stabilizer | 0 | 0 |
| Sucralose | 0.02 | 0.02 |
| Water | 62.44 | 61.7 |
| Nutritional Components (%) | | |
| Protein | 10.5 | 10.5 |
| Carbohydrates | 14.6 | 14.6 |
| Fat | 12 | 12.1 |
| Total Calories/100 g | 208 | 209 |
| Calories (%) From | | |
| protein | 20 | 20 |
| carbohydrate | 28 | 28 |
| fat | 52 | 52 |
| Fatty Acid Distribution (%) | | |
| Saturated | 15 | 15 |
| Polyunsaturated | 40 | 40 |
| Monounsaturated | 45 | 45 |

(*) Pure Kote100 from California Oils Corp.
(**) Shasta

Palm oil has a melting point profile similar to that of butterfat in regular ice cream. In some embodiments formulations that included palm oil exhibited some graininess and unacceptable hardness. On the contrary, the incorporation of shortening (partially hydrogenated vegetable fat) resulted in a product of very good quality-smooth, soft body and excellent flavor. The use of shortening should be reduced, to reduce presence of nutritionally undesirable Trans-Fatty Acids.

Regarding the protein source both whey proteins and the milk protein concentrate are suitable for this application. Whey proteins, especially in the form of an isolate, are preferred because they develop less hardness in the product. Whey proteins are processed carefully (avoiding high or extended heating) to avoid heat coagulation and the resultant textural defects and the development of “cooked” dairy flavors.

The product described herein is protein-rich and calorically dense, and given its excellent taste and texture qualities, would be a highly desirable and good-tasting food supplement for the treatment of a great variety of people who suffer from (or are at risk of developing) protein-calorie malnutrition (PCM) (a.k.a. protein-energy malnutrition or PEM), or, in certain people who consume insufficient protein, but may not have an abnormally low body fat content (“visceral protein deficiency”).

The fatty acid profile follows the pattern recommended by the American Heart Association for healthy cardiovascular system. In a preferred embodiment, the distribution of saturated/polyunsaturated/monounsaturated fatty acids in the product is 8 percent, 50 percent and 42 percent respectively. Because it has a fatty acid composition extremely low in saturated fatty acids and more than conforms to the American Heart Association's recommended fatty acid profile for the control of serum total cholesterol, it is anticipated that this product (compared to conventional ice cream) can be consumed in substantial quantities without raising the serum total (or LDL) cholesterol. It may even reduce LDL cholesterol level.

Although the product may typically be described as a frozen dessert, it is contemplated that a preferred use of the product would be in hospitals, nursing homes, and among the elderly and infirm at home, in that the product could provide a delicious high-protein, high calorie (or calorie-rich) nutritional supplement designed to help the individual who is not eating well to maintain or gain weight and to improve protein status. In effect, it is a nutritional treatment that is also a “treat.” Of course, it can also be used as a healthful dessert or snack by anyone.

The product also could be used as a meal replacement, in that it is a relatively simple matter (and well known) to combine sufficient quantities of the essential nutrients (vitamins and minerals) recommended by the Food and Nutrition Board of the National Research Council into such products. As a meal replacer, the product may also be used by overweight or obese individuals as a healthful, calorie-metered way to help control caloric intake.

Regular ice cream is low in protein and, at the same time provides an abundance of saturated fat calories. Growing children who consume ice cream in appreciable amounts are consuming too much saturated fat in a product that has a low protein to energy ratio. Children who consume too much fat (even if they do not become obese) are at risk of developing hypercholesterolemia, which is associated with an increased risk of heart disease and thrombotic stroke later in life. The product may be low in saturated fat. Also, those who enjoy eating ice cream but also wish to keep their saturated fat intake as low as possible can do so by using this product in place of conventional ice cream.

At the same time, there are various medical reasons why high caloric density food products, especially food products fortified with protein, are desired. Particularly, frail, elderly or other people with protein-calorie malnutrition (PCM), or who have a loss of appetite, or have difficulty in chewing or swallowing, or post-op patients, or people with compromised immune system or with a variety of other health disorders or who are simply concerned about their health would benefit from the highly palatable products described herein.

In cases where the fatty acid and protein characteristics are desired but a lower caloric density is required, the air content may be increased.

Other embodiments may more closely approximate ice cream qualities by adding small quantities of whipped emulsions of liquid oils and hydrogenated vegetable fats in a matrix phase comprising water, proteins and sugars, bulking agents such as maltitol, sorbitol, etc. and various gums or some amount of a high-capacity water binding material, such as gelatin, in order to attain the desired mouth feel (and organoleptic qualities).

Lower fat and cholesterol products may be achieved by using small quantities of whey and whey protein concentrate and maltodextrin or polydextrose or nondairy powder mix (such as coffee creamer).

The product may be free of lactose, trans fatty acids, and cholesterol. Products free of bulking agents, fillers and gums may reduce the likelihood of gas, bloating, diarrhea and gastrointestinal discomfort in sensitive individuals.

In some cases, the product may have no fillers or stabilizers and no trans-fatty acids, and still have good organoleptic properties.

The product takes advantage of the fact that, for example, whey protein isolate itself seems to protect fat globules from oxidation. This tends to ameliorate the susceptibility of unsaturated fatty acids to oxidation due to processing and added flavors and helps avoid the need to add an antioxidant (which may nevertheless be added).

In dry blend embodiments, the stabilizer may have the beneficial effect of reducing or eliminating foaming that would otherwise be typical of using whey protein isolate in such a product or manufacturing method.

HTST pasteurization may substantially reduce the typical coagulation of whey protein isolate when heated in such a manufacturing method.

The product is useful for the treatment of individuals who suffer from, or are at risk of developing, protein-calorie malnutrition (PCM), and it could serve as an extremely appealing nutritional supplement for such persons. The product also may appeal to healthy and well-nourished individuals who are concerned about their intake of saturated fat, their blood cholesterol levels, and their body weight, and seek a healthier lifestyle. In particular, frail and elderly persons, and hospital patients such as those who are recovering from surgery, who suffer from an impaired immune system, who have any of a variety of illnesses that give rise to, or contribute to, protein-calorie malnutrition, or who may have a loss of appetite or nausea, or may experience difficulty in swallowing or performing the work of chewing, will appreciate the product's coolness and its good-taste, satisfying organoleptic properties, and the fact that it does not need to be chewed and is easily swallowed and highly digestible. These advantages are maintained whether the product is used as a nutritional supplement or as a dessert. Additionally, since the product is lactose-free, it is particularly appropriate for use by individuals with subclinical/or symptomatic lactose intolerance.

Preferred embodiments of the product are also an excellent source of omega-3 fatty acids, in that 226 kilocalories of one of its formulations provides more than 50% of the one gram per day of omega-3 recommended for heart health by the American Heart Association.

As will be appreciated by those of ordinary skill in the art, the embodiments described herein are only several exemplary foods for providing nutritional support, which may be envisioned within the scope of this invention. For example, the embodiments described include certain ingredients in certain amounts. Other like ingredients, and different relative amounts of ingredients providing some or all of the features of the invention are contemplated as being well within the understanding of the skilled person. For example, calcium and phosphorus can be added to the product to achieve concentrations of these minerals comparable to those found in a calorically equivalent amount of whole milk.

It will also be understood by one of ordinary skill in the art that the embodiments described above can be modified and arranged to take advantage of current and emerging nutrition and food science technologies. For example, while the embodiment above describes specific protein sources, vegetable oils and corn syrup solids, new healthier ingredient substitutes are contemplated where such ingredients serve a similar function in the product of the invention. For example, other oils may be discovered in the future or processing methods devised to give oils the desired high ratio of monounsaturated fat to saturated fat and such are contemplated within the scope of this invention. Additionally, as understanding of the human health condition improves, the product of the invention may also be adapted.

These and other modifications to the construction and arrangement of the system of the invention will easily be understood to be within the scope of the claims.

It will thus be seen that the objects set forth above, among those made apparent from the preceding description, are efficiently attained and, since certain changes may be made in carrying out the above methods and in the compositions set forth without departing from the spirit and scope of the invention, it is intended that all matter contained in the above description and shown in the accompanying drawing shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A frozen or semi frozen food product, comprising:
corn syrup solids, a dry blend comprising protein and stabilizer, and vegetable oil; characterized in that the food product has high caloric density, high protein content, a fatty acid profile beneficial for healthy cardiovascular function, and exhibits satisfactory physical and sensory qualities.

2. The food product of claim 1, wherein the corn syrup solids comprise high fructose corn syrup solids.

3. The food product of claim 1, wherein the dry blend comprises one or more of whey protein isolate, whey protein concentrate, milk protein concentrate, soy protein isolate, milk protein isolate and caseinate.

4. The food product of claim 1, wherein the dry blend includes sucrose.

5. The food product of claim 1, wherein the dry blend includes artificial sweetener.

6. The food product of claim 1, wherein the vegetable oil comprises one or more of safflower oil, mixtures including safflower oil, canola oil, mixtures including canola oil, sunflower oil, mixtures including sunflower oil, corn oil, mixtures including corn oil, soybean oil, mixtures including soybean oil, cottonseed oil and mixtures including cottonseed oil.

7. The food product of claim 1, wherein the fatty acid profile has under about 20 percent saturated fat.

8. The food product of claim 1, wherein the fatty acid profile has about 8 percent saturated fat.

9. The food product of claim 1, further comprising palm kernel oil.

10. The food product of claim 1 having substantially no cholesterol

11. The food product of claim 1 having substantially no trans fatty acids.

12. The food product of claim 1 having substantially no lactose.

13. The food product of claim 1 having substantially no bulking agents.

14. The food product of claim 1 having substantially no fillers.

15. The food product of claim 1 having substantially no gums.

16. The food product of claim 1 having physical and sensory qualities substantially similar to traditional ice cream made with milk fat.

17. The food product of claim 1 wherein caloric density is at least about 180 calories per 100 grams.

18. The food product of claim 1 wherein the protein content is at least about 20% of caloric content.

19. The food product of claim 1 wherein the protein content is at least about 10% by weight.

20. A food product, comprising:
corn syrup solids, a dry blend comprising protein and stabilizer, and vegetable oil; combined to form a frozen or semi frozen food product having high caloric density, high protein content, a fatty acid profile beneficial for healthy cardiovascular function, and exhibits satisfactory physical and sensory qualities.

21. The food product of claim 20, wherein the dry blend comprises one or more of whey protein isolate, whey protein concentrate, milk protein concentrate, soy protein isolate, milk protein isolate and caseinate.

22. The food product of claim 20, wherein the vegetable oil comprises one or more of safflower oil, mixtures including safflower oil, canola oil, mixtures including canola oil, sunflower oil, mixtures including sunflower oil, corn oil, mixtures including corn oil, soybean oil, mixtures including soybean oil, cottonseed oil and mixtures including cottonseed oil.

23. The food product of claim 20, wherein the fatty acid profile has under about 20 percent saturated fat.

24. A frozen or semi frozen food product, comprising:
corn syrup solids and a dry blend comprising protein and stabilizer, and vegetable oil having a fatty acid profile beneficial for healthy cardiovascular function and having high caloric density and high protein content; characterized in that the food product exhibits desirable physical and sensory qualities.

25. The food product of claim 24, wherein the fatty acid profile has under about 20 percent saturated fat.

26. The food product of claim 24, wherein the fatty acid profile has about 8 percent saturated fat.

27. The food product of claim 24 having substantially no trans fatty acids.

28. The food product of claim 24 wherein caloric density is at least about 180 calories per 100 grams.

29. A protein fortified food product, comprising:
protein-calorie malnutrition ameliorating amounts of corn syrup solids, a dry blend comprising protein and stabilizer, and vegetable oil having a fatty acid profile beneficial for healthy cardiovascular function and having high caloric density and high protein content.

30. The food product of claim 29 wherein the protein content is at least about 20% of caloric content.

31. The food product of claim 29 wherein the protein content is at least about 10% by weight.

32. The food product of claim 29 wherein caloric density is at least about 180 calories per 100 grams.

33. The food product of claim 29, wherein the fatty acid profile has under about 20 percent saturated fat.

34. The food product of claim 29, wherein the fatty acid profile has about 8 percent saturated fat.

35. A method of manufacturing a frozen or semi frozen food product, comprising the steps of:
adding a dry blend comprising protein and stabilizer to aqueous corn syrup solids and dispersing the ingredients; mixing in vegetable oil having a fatty acid profile beneficial for healthy cardiovascular function; and cooling and aerating; characterized in that the frozen or semi frozen food product formed has high caloric density and high protein content.

36. A high caloric density and high protein content frozen or semi-frozen food or dessert product, comprising:
corn syrup solids in an amount of about 5% to 25% by weight; sugar or corn syrup in an amount of about 5% to 25% by weight; protein in an amount of from about 8% to about 35% by weight; stabilizer in an amount of up to about 1% by weight; and vegetable oil having a fatty acid profile beneficial for healthy cardiovascular function in an amount of from about 5% to about 18% by weight.

37. The food product of claim 36, wherein the protein amount is from about 15% to 30% by weight.

38. The food product of claim 36, wherein the protein amount is from about 10% to 25% by weight.

39. The food product of claim 36, wherein the protein amount is from about 15% to 25% by weight.

40. The food product of claim 36, wherein the stabilizer amount is up to about 0.2 percent by weight.

41. The food product of claim 36, wherein the fatty acid profile has under about 20 percent saturated fat.

42. The food product of claim 36, wherein the fatty acid profile has about 8 percent saturated fat.
